(19) United States
(12) Patent Application Publication
(10) Pub. No.: US 2026/0043903 A1
(43) Pub. Date: Feb. 12, 2026

(54) OPTICAL SENSOR

(71) Applicant: CANON KABUSHIKI KAISHA, Tokyo (JP)

(72) Inventors: YUSUKE SAITO, Shizuoka (JP); TATSUYA HOTOGI, Shizuoka (JP)

(21) Appl. No.: 19/294,947

(22) Filed: Aug. 8, 2025

(30) Foreign Application Priority Data
Aug. 9, 2024 (JP) 2024-133838

(51) Int. Cl. G01S 7/481

(52) U.S. Cl. CPC G01S 7/4813

(57) ABSTRACT

In an optical sensor, a copper foil pattern is arranged on a straight line between a light emitting unit and a light receiving unit on a surface of a substrate, the copper foil pattern is arranged apart from a peripheral copper foil pattern by a space, the space is arranged in each of a first region and a second region, and light to the space arranged in at least one of the first region or the second region is shieled by a light shielding member that is arranged so as to contact the substrate.

### BACKGROUND

### Field of the Technology

The present disclosure relates to a stray light reduction method that reduces generation of stray light via a substrate to enhance detection accuracy of an optical sensor.

### Description of the Related Art

In an optical sensor in which a light receiving unit receives reflected light of light emitted to an irradiation area from a light emitting unit mounted on a substrate, unintended light from the light emitting unit can enter the light receiving unit via the substrate (such light is hereinafter referred to as stray light). The entry of the stray light into the light receiving unit can cause degradation in detection accuracy. Japanese Patent Application Laid-Open No. 11-354832 discusses a method for covering the entire surface of a substrate surface with black resist or light-shielding coating solution (silk) as a countermeasure against the entry of the stray light into the light receiving unit.

However, the method for covering the entire surface of the substrate surface with the black resist or the light-shielding coating solution (silk) as discussed in Japanese Patent Application Laid-Open No. 11-354832 may be an inadequate countermeasure against the stray light if the formed black resist or light shielding coating solution has unevenness. In such a case, the light is transmitted through an area where the black resist or the light-shielding coating solution is uneven.

### SUMMARY

The present disclosure is directed to an optical sensor having a stable light-shielding property.

According to an aspect of the present disclosure, an optical sensor includes a light emitting unit configured to emit light toward an irradiation object, a light receiving unit configured to receive light emitted from the light emitting unit and then reflected by the irradiation object, a substrate having a surface on which the light emitting unit and the light receiving unit are mounted, a housing that is arranged on the surface of the substrate and configured to form a first space including the light emitting unit and a second space including the light receiving unit, the housing including a first hole portion through which light emitted from the light emitting unit passes and a second hole portion through which light reflected by the irradiation object passes, wherein, on the surface of the substrate, a first region that is a region in which the first space is projected onto the surface of the substrate and a second region that is a region in which the second space is projected onto the surface of the substrate are present, wherein a copper foil pattern is arranged on a straight line between the light emitting unit and the light receiving unit on the surface of the substrate, and the copper foil pattern is arranged apart from a peripheral copper foil pattern by a space, and wherein the space is arranged in each of the first region and the second region, and a light shielding member that is arranged so as to contact the substrate and configured to shield light to the space arranged in at least one of the first region or the second region.

According to another aspect of the present disclosure, an optical sensor includes a light emitting unit configured to emit light toward an irradiation object, a light receiving unit configured to receive light emitted from the light emitting unit and then reflected by the irradiation object, a substrate having a surface on which the light emitting unit and the light receiving unit are mounted, a housing that is arranged on the surface of the substrate and configured to form a first space including the light emitting unit and a second space including the light receiving unit, the housing including a first hole portion through which light emitted from the light emitting unit passes and a second hole portion through which light reflected by the irradiation object passes, wherein, on the surface of the substrate, a first region that is a region in which the first space is projected onto the surface of the substrate and a second region that is a region in which the second space is projected onto the surface of the substrate are present, wherein a first copper foil pattern for application of power to the light emitting unit and a second copper foil pattern for application of power to the light receiving unit are arranged on a straight line between the light emitting unit and the light receiving unit on the surface of the substrate, the first copper foil pattern and the second copper foil pattern being arranged apart from each other by a space, and wherein a portion by which the first space and the second space of the housing is partitioned is arranged to overlap the space when seen in a direction perpendicular to the surface of the substrate so that the space is not arranged in at least one of the first region or the second region.

According to the present disclosure, therefore, an optical sensor having a stable light-shielding property can be provided.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an optical sensor according to a first embodiment.

FIG. 2 is a wiring diagram of wiring on a substrate according to the first embodiment.

FIG. 3 is a schematic diagram of an optical sensor according to a second embodiment.

FIG. 4 is a wiring diagram of wiring on a substrate according to the second embodiment.

FIGS. 5A and 5B are wiring diagrams of wiring on a substrate in a modification example of the second embodiment.

### DESCRIPTION OF THE EMBODIMENTS

Embodiments of the disclosure are described with reference to the drawings.

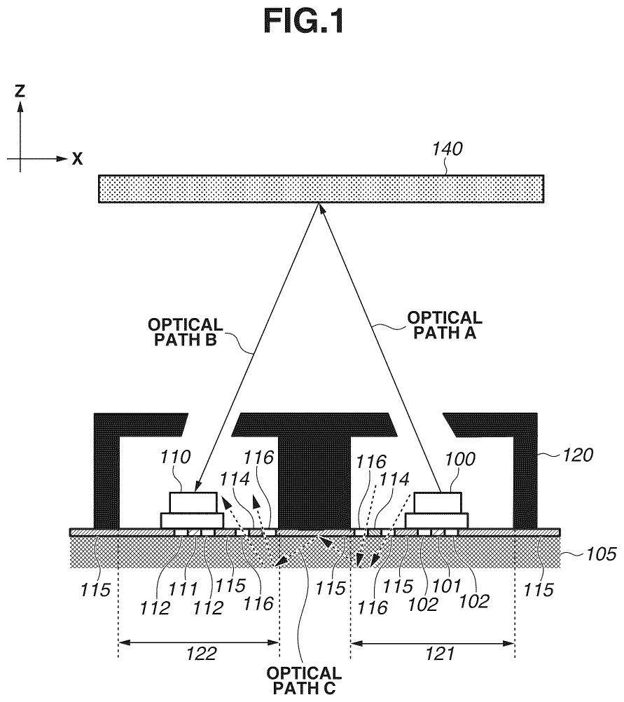

FIG. 1 is a schematic diagram (a side view) of an optical sensor according to a first embodiment.

As illustrated in FIG. 1, the optical sensor includes a light emitting diode (LED) 100 that is a light emitting unit, a photo diode (PD) 110 that is a light receiving unit for receiving light, a substrate 105, an aperture (a housing) 120 that narrows the light to be received by the PD 110, and a reflection plate (an irradiation object) 140 that reflects the light from the LED 100. The LED 100 and the PD 110 are mounted on the same surface of the substrate 105. The aperture 120 is disposed on the surface of the substrate 105 on which the LED 100 and the photo diode 110 are mounted. One example of the substrate 105 includes a low-cost paper phenol substrate. The light emitted by the LED 100 forms an optical path A that is narrowed by the aperture 120. As for the light in the optical path A, the light emitted through a first hole portion in a first space within the aperture 120 is reflected by the reflection plate 140. Out of the reflected light, the light in an optical path B that passes through a second hole portion of the aperture 120 is received by the photo diode 110 in a second space. Because the aperture 120 is made of a member having a high light-shielding property, internal light barely leaks out by passing through the aperture 120, and external light barely enters the inside of the aperture 120 by passing through the aperture 120.

On the substrate 105, an LED copper foil pattern 101 is wired. The LED copper foil pattern 101 is a first copper foil pattern to supply power to the LED 100 by application of power. The LED copper foil pattern 101 and a peripheral copper foil pattern 115 are arranged apart by a distance of a LED wiring space 102 and wired. Similarly, a PD copper foil pattern 111 (a second copper foil pattern) and a peripheral copper foil pattern 115 are arranged apart by a distance of a PD wiring space 112 and wired. The PD copper foil pattern 111 is used to supply power and a signal to the photo diode 110 by application of power. A plurality of wiring copper foil patterns 114 for operating a peripheral circuit is arranged apart from the peripheral copper foil pattern 115 or a light-shielding copper foil pattern 117 by a distance of a wiring space 116 and is wired. The light-shielding copper foil pattern 117 is a third copper foil pattern. The LED copper foil pattern 101 and a PD wiring pattern can be wired between the LED 100 and the photo diode 110 as similar to the wiring copper foil pattern 114, depending on a wiring method. A region in which not only the first space is projected onto a surface of the substrate 105 but also the aperture 120 is not in contact with the substrate 105 is a first region 121 that is an area having no aperture. A region in which not only the second space is projected onto a surface of the substrate 105 but also the aperture 120 is not in contact with the substrate 105 is a second region 122 that is an area having no aperture. That is, the optical sensor has the first region 121 and the second region 122. Each of the LED copper foil pattern 101, the PD copper foil pattern 111, and the wiring copper foil pattern 114 is formed of metal, and thus light does not pass through the copper foil patterns 101, 111, and 114. On the other hand, each of the LED wiring space 102, the PD wiring space 112, and the wiring space 116 is not covered with a material having a high light-shielding property, and thus the light emitted from the LED easily passes through the wiring spaces 102, 112, and 116.

Most of the light emitted from the LED 100 becomes optical paths A and B. However, as illustrated in an optical path C, a part of the light emitted from the LED 100 passes through the wiring space 116 through which light easily passes, and is diffusely reflected inside the substrate 105. The diffusely reflected light may be emitted from the wiring space 116, and such light may be received as stray light by the photo diode 110.

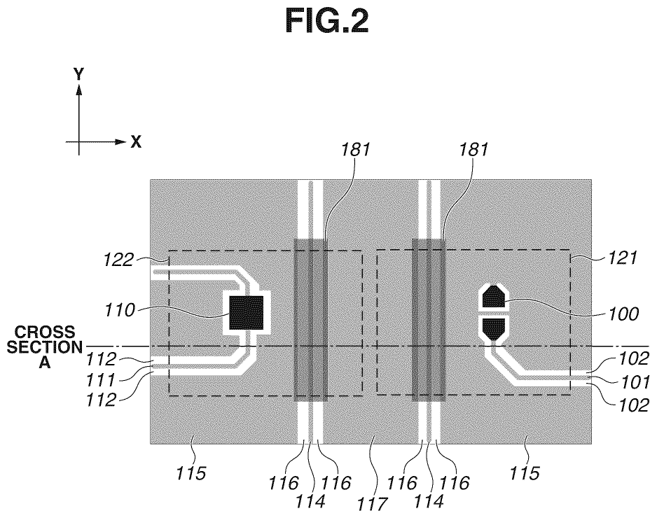

FIG. 2 is a wiring diagram (a top view) of wiring on the substrate when the optical sensor is seen from above. FIG. 1 illustrates a cross-section A of FIG. 2. Since the substrate 105 and the aperture 120 are in contact with each other outside the first region 121 and the second region 122, light that enters from the outside is extremely little.

The wiring copper foil pattern 114 can be electrically connected to the LED copper foil pattern 101, the PD copper foil pattern 111, or the peripheral copper foil pattern 115, or can be a copper foil pattern that is not electrically connected.

The light-shielding copper foil pattern 117 arranged between the LED 100 and the photo diode 110 can be a copper foil pattern that is not electrically connected to the LED copper foil pattern 101, the PD copper foil pattern 111, the wiring copper foil pattern 114, or the peripheral copper foil pattern 115.

A description is given of a countermeasure against stray light in the first region 121. The first region 121 includes the LED wiring space 102 and a wiring space 116. The light emitted from the LED 100 may enter the inside of the substrate 105 via the LED wiring space 102 and the wiring space 116. The wiring space 116 is arranged on a straight line between the LED 100 and the photo diode 110, and the stray light entered from the wiring space 116 exerts a significant influence on wrong detection or accuracy degradation at the photo diode 110. According to the present disclosure, a light-shielding member 181 is arranged above the wiring space 116 of the first region 121, so that influence of the stray light is reduced.

The second region 122 includes the PD wiring space 112 and a wiring space 116.

The light emitted from the LED 100 may enter the inside of the substrate 105 via any of the PD wiring space 112 and the wiring space 116. As mentioned above, the wiring space 116 exerts a significant influence on wrong detection or accuracy degradation at the photo diode 110. According to the present disclosure, a light-shielding member 181 is arranged on the wiring space 116 of the second region 122, so that influence of the stray light is reduced.

As for the light-shielding member 181, any member having a high light-shielding property such as light-shielding tape having a light-shielding property or black silk having a light-shielding property can be employed.

As described above, since the wiring space 116 causes stray light, the light-shielding member 181 is arranged on each of the wiring spaces 116 of the first region 121 and the second region 122. Such arrangement with a minimal additional member can reduce wrong detection and degradation in detection accuracy due the stray light.

The light-shielding member 181 may cover any one of the wiring spaces 116 of the first region 121 and the second region 122.

The optical sensor of the present embodiment can be used, for example, as a sheet detection sensor in an image forming apparatus.

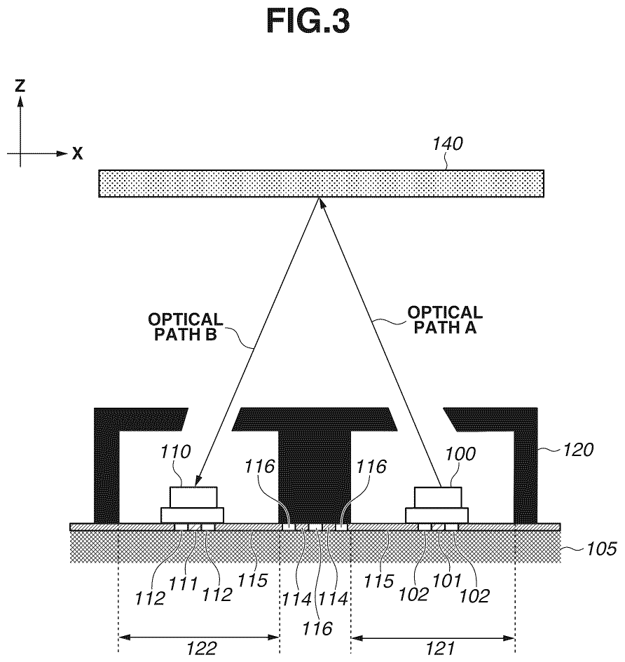

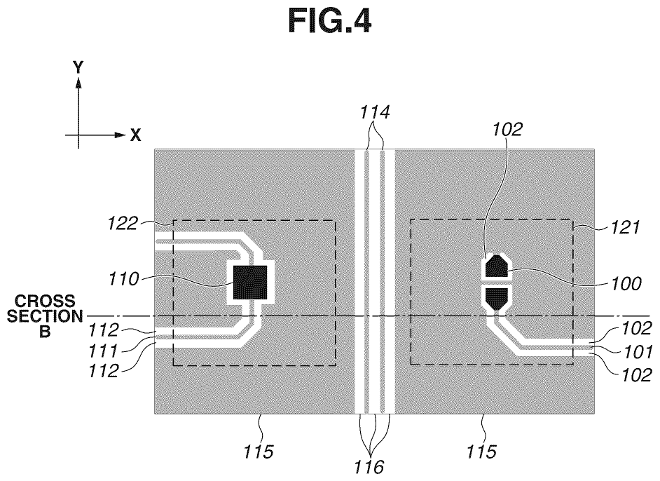

In a second embodiment, as illustrated in FIGS. 3 and 4, an aperture 120 doubles as a light shielding member. With such an aperture 120, wrong detection and accuracy degradation due to stray light is reduced without wiring spaces 116 within areas of a first region 121 and a second region 122.

On the substrate 105 arranged in the optical sensor according to the first embodiment, the LED copper foil pattern 101 is wired. The LED copper foil pattern 101 is a first copper foil pattern for supply of power to the LED 100 by application of power. The LED copper foil pattern 101 and the peripheral copper foil pattern 115 are arranged apart by a distance of the LED wiring space 102 and wired. Similarly, the PD copper foil pattern 111 and the peripheral copper foil pattern 115 are arranged apart by a distance of the PD wiring space 112 and wired. The PD copper foil pattern 111 is a second copper foil pattern to supply power or a signal to the photo diode 110 by application of power. The plurality of wiring copper foil patterns 114 for operating a peripheral circuit is arranged apart from the peripheral copper foil pattern 115 or the light-shielding copper foil pattern 117 by a distance of the wiring space 116 and is wired. The light-shielding copper foil pattern 117 is a third copper foil pattern.

The wiring copper foil pattern 114 can be electrically connected to the LED copper foil pattern 101, the PD copper foil pattern 111, or the peripheral copper foil pattern 115, or can be a copper foil pattern that is not electrically connected.

The light-shielding copper foil pattern 117 arranged between the LED 100 and the photo diode 110 can be a copper foil pattern that is not electrically connected to the LED copper foil pattern 101, the PD copper foil pattern 111, the wiring copper foil pattern 114, or the peripheral copper foil pattern 115.

FIG. 3 is a schematic diagram (a side view) illustrating a configuration of an optical sensor according to the second embodiment, and corresponds to a cross section B of FIG. 4. Components and configurations similar to those of the first embodiment are given the same reference numerals as above and descriptions thereof are omitted. A portion by which a first space and a second space of the aperture 120 are partitioned is arranged to overlap the wiring space 116 when seen in a direction perpendicular to a surface of the substrate 105.

FIG. 4 is a wiring diagram (a top view) of wiring on a substrate when the optical sensor of the second embodiment is seen from above.

The wiring space 116 is arranged on a straight line between the LED 100 and the photo diode 110. However, the wiring space 116 is not arranged in the first region 121 or the second region 122. Thus, the light emitted from the LED 100 does not enter the wiring space 116, so that wrong detection or accuracy degradation at the photo diode 110 due to stray light can be reduced.

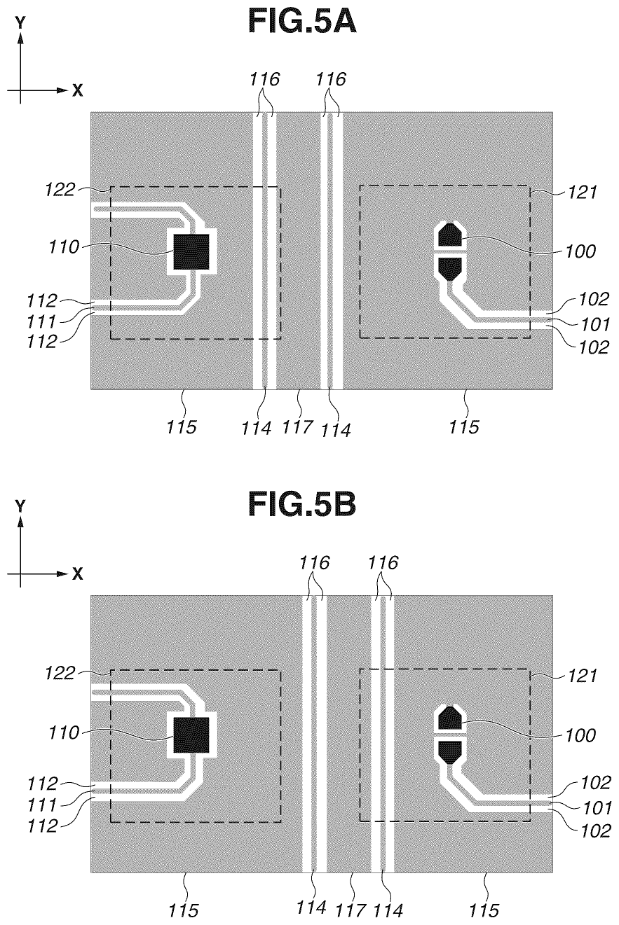

As illustrated in FIGS. 5A and 5B, at least one of the first region 121 and the second region 122 may be configured such that the wiring space 116 is in contact with the aperture 120. Such a configuration can also reduce stray light.

As described above, a shape of the aperture 120 and an arrangement position of the wiring space 116 are devised, so that wrong detection and detection accuracy due to stray light can be reduced without addition of a new light shielding member, compared to the first embodiment.

The optical sensor of the present embodiment can be used as, for example, a sheet detection sensor in an image forming apparatus.

The present disclosure includes a configuration example and a method example as follows.

### Item 1

An optical sensor includes a light emitting unit configured to emit light toward an irradiation object, a light receiving unit configured to receive light emitted from the light emitting unit and then reflected by the irradiation object, a substrate having a surface on which the light emitting unit and the light receiving unit are mounted, and a housing that is arranged on the surface of the substrate on which the light emitting unit is mounted and configured to form a first space including the light emitting unit and a second space including the light receiving unit, the housing including a first hole portion through which light emitted from the light emitting unit passes and a second hole portion through which light reflected by the irradiation object passes. On the surface of the substrate, a first region that is a region in which the first space is projected onto the surface of the surface and a second region that is a region in which the second space is projected onto the surface of the surface are present. A copper foil pattern is arranged on a straight line between the light emitting unit and the light receiving unit on the surface of the substrate, and the copper foil pattern is arranged apart from a peripheral copper foil pattern by a space. The space is arranged in each of the first region and the second region, and light to the space arranged in at least one of the first region and the second region is shieled by a light shielding member that is arranged so as to contact the substrate.

### Item 2

In the optical sensor according to the item 1, a copper foil pattern that is arranged between the space in the first region and the space in the second region is not electrically connected to the light emitting unit or the light receiving unit.

### Item 3

In the optical sensor according to the item 1, the light shielding member is tape having a light-shielding property.

### Item 4

In the optical sensor according to the item 1, the light shielding member is silk having a light-shielding property.

### Item 5

An optical sensor includes a light emitting unit configured to emit light toward an irradiation object, a light receiving unit configured to receive light emitted from the light emitting unit and then reflected by the irradiation object, a substrate having a surface on which the light emitting unit and the light receiving unit are mounted, and a housing that is arranged on the surface of the substrate on which the light emitting unit is mounted and configured to form a first space including the light emitting unit and a second space including the light receiving unit, the housing including a first hole portion through which light emitted from the light emitting unit passes and a second hole portion through which light reflected by the irradiation object passes. On the surface of the substrate, a first region that is a region in which the first space is projected onto the surface of the surface and a second region that is a region in which the second space is projected onto the surface of the surface are present. A first copper foil pattern for application of power to the light emitting unit and a second copper foil pattern for application of power to the light receiving unit are arranged on a straight line between the light emitting unit and the light receiving unit on the surface of the substrate. The first copper foil pattern and the second copper foil pattern are arranged apart from each other by a space. A portion by which the first space and the second space of the housing is partitioned is arranged to overlap the space when seen in a direction perpendicular to the surface of the substrate so that the space is not arranged in at least one of the first region and the second region.

### Item 6

In the optical sensor according to the item 5, a third copper foil pattern that is not electrically connected to the first copper foil pattern or the second copper foil pattern is arranged in the space.

### Item 7

In the optical sensor according to the item 1, the substrate is a paper phenol substrate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-133838, filed Aug. 9, 2024, which is hereby incorporated by reference herein in its entirety.

What is claimed is:

1. An optical sensor comprising:
a light emitting unit configured to emit light toward an irradiation object;
a light receiving unit configured to receive light emitted from the light emitting unit and then reflected by the irradiation object;
a substrate having a surface on which the light emitting unit and the light receiving unit are mounted;
a housing that is arranged on the surface of the substrate and configured to form a first space including the light emitting unit and a second space including the light receiving unit, the housing including a first hole portion through which light emitted from the light emitting unit passes and a second hole portion through which light reflected by the irradiation object passes,
wherein, on the surface of the substrate, a first region that is a region in which the first space is projected onto the surface of the substrate and a second region that is a region in which the second space is projected onto the surface of the substrate are present,
wherein a copper foil pattern is arranged on a straight line between the light emitting unit and the light receiving unit on the surface of the substrate, and the copper foil pattern is arranged apart from a peripheral copper foil pattern by a space, and
wherein the space is arranged in each of the first region and the second region; and
a light shielding member that is arranged so as to contact the substrate and configured to shield light to the space arranged in at least one of the first region or the second region.

2. The optical sensor according to claim 1, wherein a copper foil pattern that is arranged between the space in the first region and the space in the second region is not electrically connected to the light emitting unit or the light receiving unit.

3. The optical sensor according to claim 1, wherein the light shielding member includes tape having a light-shielding property.

4. The optical sensor according to claim 1, wherein the light shielding member includes silk having a light-shielding property.

5. An optical sensor comprising:
a light emitting unit configured to emit light toward an irradiation object;
a light receiving unit configured to receive light emitted from the light emitting unit and then reflected by the irradiation object;
a substrate having a surface on which the light emitting unit and the light receiving unit are mounted;
a housing that is arranged on the surface of the substrate and configured to form a first space including the light emitting unit and a second space including the light receiving unit, the housing including a first hole portion through which light emitted from the light emitting unit passes and a second hole portion through which light reflected by the irradiation object passes,
wherein, on the surface of the substrate, a first region that is a region in which the first space is projected onto the surface of the substrate and a second region that is a region in which the second space is projected onto the surface of the substrate are present,
wherein a first copper foil pattern for application of power to the light emitting unit and a second copper foil pattern for application of power to the light receiving unit are arranged on a straight line between the light emitting unit and the light receiving unit on the surface of the substrate, the first copper foil pattern and the second copper foil pattern being arranged apart from each other by a space, and
wherein a portion by which the first space and the second space of the housing is partitioned is arranged to overlap the space when seen in a direction perpendicular to the surface of the substrate so that the space is not arranged in at least one of the first region or the second region.

6. The optical sensor according to claim 5, wherein a third copper foil pattern that is not electrically connected to the first copper foil pattern or the second copper foil pattern is arranged in the space.

7. The optical sensor according to claim 1, wherein the substrate includes a paper phenol substrate.
